(19) United States
(12) Patent Application Publication
(10) Pub. No.: US 2024/0030968 A1
(43) Pub. Date: Jan. 25, 2024

(54) SYSTEM AND METHOD FOR JOINT USER PRIORITIZATION AND ANTENNA ALLOCATION IN MASSIVE MU-MIMO

(71) Applicant: Ulak Haberlesme A.S., Ankara (TR)

(72) Inventors: Ali Arsal, Ankara (TR); Zeynep Gul Pehlivanli, Ankara (TR)

(73) Assignee: Ulak Haberlesme A.S., Ankara (TR)

(21) Appl. No.: 18/220,848

(22) Filed: Jul. 12, 2023

Related U.S. Application Data
(60) Provisional application No. 63/390,957, filed on Jul. 20, 2022.

(51) Int. Cl. H04B 7/0452; H04B 7/06; H04L 5/00; H04W 72/56

(52) U.S. Cl. CPC H04B 7/0452; H04B 7/0626; H04L 5/0005; H04W 72/56

(57) ABSTRACT

Massive MU-MIMO employs thousands of antennas at the base station. The number of antennas required to serve users vary from time to time as the number and profile of users change, affecting the operational efficiency of the base station. The embodiments presented here is a computationally efficient heuristic method and system components at the next generation base station transmitter that selects best set of antennas, limited by the total number of transmitter RF chains, and the corresponding prioritized set of users to be served by a time-frequency radio resource at time t. The method starts by selecting a group of antennas, and prioritizing users for that group using channel state information (CSI), and then by iteratively or concurrently adding (or deleting) antennas, and correspondingly by adding (or deleting) users at each step using a method to jointly solve the problem of selecting antennas and prioritizing users.

### CROSS REFERENCE TO THE RELATED APPLICATIONS

This application claims priority to provisional application 63390957, filed on Jul. 20, 2022, the entire content of which is incorporated herein by reference.

### TECHNICAL FIELD

The present invention relates generally to an apparatus and method for a base station of a cellular network and particularly for antenna and user selection for data transmission in 5G and 6G cellular networks with large number of antennas.

### BACKGROUND

Any discussion of the prior art throughout the specification should in no way be considered as an admission that such prior art is widely known or forms part of common general knowledge in the field.

### Key Words

BS, gNB, MU-MIMO, Ultra Massive, CSI, Beamforming, Precoding, ZF, DPC, Scheduling.

### REFERENCES CITED

### U.S. Patent Documents

[1] U.S. Pat. No. 8,019,031, Sep. 13, 2011.
[2] U.S. Pat. No. 9,407,337 B2, Aug. 2, 2016.

### Other Documents

[1]. GPP Release 11, Https://Www.3gpp.Org/Specifications/Releases/69-Release-11
[2]. E. Castaneda Et. Al. ‘An Overview on Resource Allocation Techniques for Multi-User MIMO Systems’, IEEE Communications Surveys & Tutorials, Vol. 19, No. 1, First Quarter 2017.
[3]. M. Olyaee et. al., ‘An energy-efficient joint antenna and user selection algorithm for multi-user massive MIMO downlink’, IET Communications, 2018, Vol. 12 Iss. 3, pp. 255-260, The Institution of Engineering and Technology 2017.
[4]. Yoo, T., Goldsmith, A., ‘On the optimality of multiantenna broadcast scheduling using zero-forcing beamforming’, IEEE Journal on Selected Areas in Communications, Vol. 24, No. 3, March 2006.

### Discussion of Related Art

Acronyms and Definitions

| | |
|---|---|
| A/D | Analog to Digital |
| 3GPP | 3^{rd} Generation Partnership Program |
| BS | Base Station |
| C/I | Carrier to Interference Ratio |
| CSI | Channel State Information |
| CU | Centralized Unit |
| DL | Down Link |
| DPC | Dirty Paper Coding |
| DU | Distributed Unit |
| EE | Energy Efficiency |
| gNB | gNodeB (BS of 5G network) |
| GS | Gram-Schmidt |
| LTE | Long Term Evolution |
| MIMO | Multi Input Multi Output |
| MU | Multi-User |
| NPI | Network Performance Index |
| NR | New Radio |
| OFDM | Orthogonal Frequency Division Multiple |
| PF | Proportional Fairness |
| RAN | Radio Access Network |
| RF | Radio Frequency |
| RU | Radio Unit |
| SE | Spectral Efficiency (bits/sec/hertz) |
| SINR | Signal to Interference-plus-Noise Ratio |
| TTI | Transmission Time Interval |
| TX | Transmitter |
| UE | User Equipment |
| UM | Ultra-Massive |
| UL | Uplink |
| ZF | Zero-Forcing |

Underlying technology in MIMO is beamforming, which is the ability of the base station to change the radiation pattern of each antenna, enabling the base station to find a suitable route to deliver data to the user by engaging all (or some) antennas such that the interference to neighboring users along a chosen routes to the user is minimized. Beamforming is essentially a signal processing procedure used with multiple antennas to simultaneously send multiple signals to each user.

For MIMO systems, beamforming helps with increasing received signal to noise ratio (SNR) by enabling the base station to route the data to the user from various paths. Furthermore, beamforming helps to send concentrated beams towards the users through different paths—particularly given that the electromagnetic waves can't penetrate through obstacles and can't propagate to longer distances due to a short wavelength. The objective of beamforming in a base station is to maximize each user's received signal strength while minimizing so-called co-channel interference signal to the unintended users. It can be achieved by transmitting the same user signal from multiple antennas such that each signal sent by an antenna is multiplied with a complex coefficient resulting in a different signal amplitude and phase. This process so-called precoding' is well known in prior art. Dirty Paper Coding (DPC) and Zero Forcing (ZF) precoding are two such popular techniques. The receiver adds up the received radio signals through said multiple antennas to get the transmitted user signal. The multiple versions of the transmitted signal will essentially pass through radio channels with different channel characteristics. They are added constructively at the user while being canceled out at the other users minimizing interference.

Beamforming is realized by assembling the antenna elements in a so-called ‘organized array’ with hundreds or thousands of antennas, in which beams are steered toward specific directions. Although there will be large number of antennas in the array, the number of radio frequency (RF) chains may still be smaller. The RF-chain is comprised of an expensive cascade of electronic components for physical layer processing that include power amplifier, filter, mixer, Analog to Digital converter, downconverter, and Digital to Analog converter. Once an antenna is chosen to transmit user signals, an available RF-chain will be assigned to it. Since one RF-chain can serve only one user's data, the number of simultaneously transmitted different user signals is limited to number of RF-chains.

Although beamforming is not new, it found a great application in cellular networks where the radio transmission capacity is a finite resource. The MU-MIMO according to aspects of this invention can be a massive MU-MIMO as in 5G, or ultra-massive (UM) MU-MIMO as in 6G for emerging machine-to-machine and IoT applications. While massive MIMO may have hundreds of antennas, UM-MIMO may have many thousands of antennas serving large number of devices in a cell.

The 5G New Radio (NR) specification of 3 GPP [1] provides a distributed architecture for the base station (also known as gNodeB) that is comprised on a Central Unit (CU), many Distributed Units (DUs) and many Radio Units (RUs) wherein these components interwork according to specified protocols. The CU provides the higher-layer non-real-time functions, DUs provide Radio Link Control (RLC), Medium Access Control (MAC) and higher Physical Layer functions, and RUs provide lower Physical Layer functions including OFDM signal processing. In a massive MIMO gNodeB, a plurality of antennas and RF-chains are placed on each RU. The user scheduling task is generally performed within the processor of the DU. In some Radio Access Network (RAN) architectures, the RU and DU may be collocated. Alternatively, one DU may support many RUs wherein DU and RU are connected with high-speed fiber optic links.

In summary, beamforming creates a new dimension in resource allocation to users. The first set of resource dimensions known in cellular networks are frequency, time, code, and power wherein each user is assigned these resources in an optimized way by the base station through a process well-known in prior art as ‘user scheduling’. With beamforming, the spatial multiplexing caused a dimension (direction) to be added to resources. We must determine which direction to serve each user, what signal to send with how many resource blocks, and how many antennas to engage.

mIn the embodiments of this invention, we consider a multi-user massive or ultra-massive MIMO system consisting of an M_{T}-antenna Base Station (BS) transmitter that is limited by R_{T} RF chains, and N single-antenna receivers at the user equipment (UE) forming a cell as illustrated in FIG. 1. In one cell, we have a maximum of R_{T} antennas to transmit data at any time to N users wherein the antennas can be selected from the group of M_{T} antennas, and a maximum of R_{T} UEs from a set of N UEs, each user to receive data from the set of selected antennas. The goal is to configure the downlink transmission from the BS (gNodeB) to a group of selected UEs at any time-period t to maximize the spectral efficiency with least possible number of antennas, i.e., we need to determine number of antennas (limited by the number of RF-chains) and number of served (prioritized) users, namely, Mₜ and Nₜ, respectively at time t.

During a transmission interval t, the base station allocates Mₜ number of antennas to each UE, sending that UE's data from all antennas to create the beam. The t^{th} transmission time interval (TTI) is a fixed time-period T. When deciding the number of antennas serving user's data, the considered key UE properties include the channel quality and throughput. Although Quality of Service (QoS) requested by the user's application is of concern in user selection, it is omitted here for simplification. For any chosen time-frequency resource-block, the mapping of users to this resource-block consists of three coupled key functions:
User selection: Prioritizing the users to be served at any TTI and selecting the top ranked users.
Antenna allocation: Selecting the number and set of antennas to serve selected set of users.
Precoding: Pre-processing selected user signals before transmitting through allocated antennas to compensate for channel effects such as interference and fading.

The problem is very complex as there are many resources to allocate. The typical solution to resource allocation at any time t decouples the problems of allocating time and frequency resources to users from the problem of user selection and antenna allocation, creating two separate relatively simpler problems. Beamforming enables multiple users' signals to be carried through the same time-frequency resource.

The decoupling greatly simplifies the problem. The simplification is important as the base station must make resource assignment in real-time and therefore the algorithm must not require extensive processing. It must be simple and highly efficient. Especially in massive MIMO, the number of antennas is extremely large and hence the problem dimensions. Luckily, not all antennas must be engaged to serve the users. Much smaller number of antennas may simply be sufficient based on number of UEs, the channel quality, and amount of data to be transmitted. Each antenna and associated RF chain consumes power and thus must be engaged only if required. The best set of antennas can be chosen in such a way that a chosen ‘network performance metric’ is satisfied.

### Technical Problem

One of the main challenges of adopting massive or ultra-massive MIMO is its high cost and complexity due to deployment of large number of antennas. Antenna selection is an efficiency improving technique to reduce the number of RF chains and enhance the overall electric energy consumption of the base station in real-time. The base station energy consumption is linearly proportional with the number of antennas engaged in transmitting signals. So, it is desirable to use only the necessary number of antennas to meet the user throughput needs. Once the right antennas are selected it is imperative to select the best group of users to be served accounting for radio channel characteristics between users and chosen antennas and the physical distance between each user and base station to account for fading prevalent in electromagnetic waves.

### SUMMARY

In the first embodiment, the antenna allocation results in determining [symbol] ={Mₜ|1≤t≤T; Mₜ«M_{T}}, which is an ordered set of Mₜ out of M_{T} antennas, wherein these antennas are ranked and assigned to those selected UEs determined as a result of user prioritization that are in set [symbol] wherein set [symbol] ={Nₜ|1≤t≤; Nₜ«N} which is an ordered set of Nₜ out of N users that have requested data to be transmitted at t. Not only the number of antennas and users, but the specific antennas and users are selected based on properties of the channel matrix.

In the second embodiment, all M_{T} transmit antennas are engaged to properly to form a beam and serve UEs at time t, i.e., Mₜ=M_{T}. The UEs are prioritized because M_{T}«N. This embodiment corresponds to the real-life case of much fewer number of antennas than users as in MU-MIMO case, e.g., in LTE, and eliminates the need for antenna allocation problem. This embodiment contains only user prioritization.

The first embodiment is a coupled user selection and antenna allocation methods and system within the BS transmitter in a single cell wherein pre-coding is applied to user signals. The precoding techniques require the knowledge of the channel state information (CSI) between antennas and users, which is obtained using so-called pilot/training signals transmitted by the base station to each user. The CSI refers to known channel properties of the radio communication link that describes how a signal propagates from the transmitter to the receiver representing the combined effect of signal impairments. The CSI makes it possible to adapt transmissions to current channel conditions, which is crucial for achieving reliable communication with high data rates in multiantenna systems.

Although there are many prior art techniques, the Zero Forcing (ZF) precoding [2] can be applied that greatly simplifies the user selection process. The ZF precoding matrix [symbol] corresponds to the system at time-period t for given number of antennas and users, i.e., Wₜ=W(Mₜ, Nₜ). The precoding matrix, however, changes at each time-period t if the number of antennas servicing users and/or the number of users change. The pseudo-inverse operation used to obtain the ZF-precoding matrix, [symbol] , restricts the number of users to be less than or equal to the number of transmit antennas, Mₜ. When there are more than Mₜ users in the system only a subset of Mₜ users must be selected to use ZF precoding, ZF-precoding is a well-known process in prior art that processes a user's signal, z, to determine what each antenna must transmit, i.e., x₁, x₂, . . . , x_{Mt} wherein xᵢ=wᵢ [symbol] wherein wᵢ is a complex multiplier that basically modifies the gain and phase of user signal z by each antenna to achieve beamforming.

The method iteratively allocates antennas (less than or equal to number of RF chains) and then selects/prioritizes a subset of users equal to the number to the selected antennas such that, when converged, the total RAN's Carrier to Interference ratio (C/I) used as a measure of spectral efficiency is highest for the chosen group of users wherein C/I is computed by applying precoding to user signals. An alternative metric is the incremental spectral efficiency per antenna using (C/I/Mₜ) which factors in energy efficiency of the base station. The performance metric is reconfigurable from time to time.

The initial group of antennas is selected by ranking of the antennas according to the CSI represented by the channel matrix at time t. Then, the selected number of antennas are either reduced one by one (or increased one by one), in turn reducing by one (or increasing by one) the number of UEs served. At each reduction (or increase), the corresponding prioritized set of Nₜ UEs are selected according to a method of this invention. At each step, precoding is applied, and the performance metric is evaluated to test the selected configuration until convergence.

The outcome of user selection (sometimes referred as user prioritization) is defined as selection of an ordered subset of UEs containing the ones that have requested data to be transmitted at time t. This is a user ranking process that results in a list of UEs. Most existing algorithms search for the prioritized group of UEs for a predetermined (fixed) number of antennas (that is usually the maximum number of antennas of the base station). This assumption is relaxed, and an iterative (or concurrent) search is performed for best set of prioritized UEs to be served by a given number of antennas Mₜ. The problem solved according to this invention is essentially a user prioritization at time t, such that Nₜ number of users are prioritized for transmission using beams formed by Mₜ antennas for each resource block (time and frequency). The user prioritization problem is repeated for each selection of Mₜ. The remaining users (N-Nₜ) are served by the next time-frequency resources simply by repeating the process.

To find that optimal the set of UEs, an exhaustive search needs to be performed, which has exponential complexity order. Hence, many heuristic user prioritization techniques have been proposed in prior art. For example, in a method presented in U.S. Pat. No. 8,019,031 B2 users are selected based on a metric of orthogonality by calculating an orthogonal coefficient by using a channel vector of each user and a projection channel vector updated after a previous user selection, calculating a correction Signal to Interference plus Noise Ratio (SINR) by using the received SINR and the orthogonal coefficient. Then selecting a user by using the correction SINR and updating the projection channel vector by using Gram Schmidt (GS) orthogonalization known in prior art for a next user selection.

Many methods are also proposed in prior art for antenna selection. In a method presented in U.S. Pat. No. 9,407,337, all possible combinations of Mₜ number of antennas that are a subset of M_{T} antennas are evaluated using an exhaustive enumeration. However, this technique is computationally inefficient for massive or ultra-massive MIMO when M_{T} is large. Similarly, in Olyaee et. al. [3], the authors propose a joint antenna selection and user prioritization by an iterative process starting with the total number of antennas, MT, then by reducing the number of antennas one at a time to minimize energy efficiency and determining the corresponding set of prioritized users using the Semiorthogonal User Selection (SUS) method of Yoo and Goldsmith [4]. However, for massive MIMO, this process is highly inefficient as it requires many complex iterative computations until convergence.

### User Prioritization

The user prioritization method according to an aspect of this invention aims at selecting Nt number of UEs from N number of UEs at time t where Nₜ«N, such that each selected UE, denoted as sUE, is an element of the ordered set, i.e., sUE E (sUE₁, sUE₂, . . . , sEU_{Nt}), while maximizing the objective function of total channel norm of selected sUEs in the cell of base station j, i.e., BSⱼ, expressed as:

$${max}_{i} {\sum }_{i}^{{N}_{t}} \vert ‖ {h}_{ij} ‖ {r}_{ij}^{- α / 2} \vert \qquad ( 1 )$$

subject to total interference between selected sUEs being limited by a tolerance:

Σₖ₌₁^{Nt}Σᵤ₌ₖ₊₁^{Nt}cᵤₖ<ε (2a)

where the interference is expressed as:

$${c}_{uk} = ( \frac{\vert {h}_{uj}^{H} {h}_{kj} \vert}{‖ {h}_{uj} ‖ ‖ {h}_{kj} ‖} ) \qquad ( 2 b )$$

Here,
   |⋅| is absolute value,
∥⋅∥ is the vector norm,
ε is a configurable maximum interference tolerance of the cell,
α is the path loss coefficient,
rᵢⱼ is the distance between sUEᵢ and BSⱼ, and
hᵤⱼ^{H} is the conjugate transpose of hᵤⱼ.

Vector hᵢⱼ∈C^{1×M}^{ₜ} contains independent and identically distributed random variables with complex Gaussian distribution representing channel vector between sUEᵢ and BSⱼ when there are Mₜ transmit antennas used to send user's data, i.e., hᵢⱼ≡hⱼ=└hᵢ₁hᵢ₂ . . . h_{IM}_{ₜ}┘ (note that the index j is not shown in each element for simplicity).

Eq. (2b) is the dot-product between two vectors normalized by their vector norms, which is well known in prior art. If vectors hᵤⱼ and hₖⱼ are orthogonal cᵤₖ=0. If vectors hᵤⱼ and hₖⱼ are parallel cᵤₖ=1.

15 Since there is no analytical solution to the non-linear optimization problem stated above, a simple heuristic solution that is efficient is devised according to an aspect of this invention using the following steps:

Step-1: Select the first user, sUE₁, as UEᵤ which has the maximum channel norm:

$$\begin{matrix}u = arg {max}_{i} ‖ {h}_{ij} {r}_{ij}^{- α / 2} ‖ & i = 1 , 2 , … , N\end{matrix} \qquad ( 3 )$$

Step-2: Select the second user, sUE₂, as UEₖ which has a weighted maximum channel norm by accounting for its channel vector's correlation to the chosen first user before precoding:

$$\begin{matrix}k = arg {max}_{i} ( ‖ {h}_{ij} {r}_{ij}^{- α / 2} ‖ ( 1 - {c}_{ui} ) ) & i = 1 , 2 , … , N and i \neq u\end{matrix} \qquad ( 4 )$$

Here cᵤᵢ is the correlation coefficient of channels between UE and previously chosen sUE₁≡UEᵤ. The selection metric of Eq. (4) aims at choosing UEₖ such that not only its channel quality is good but least correlated (loosely speaking, most orthogonal) to the previously chosen UEᵤ's channel norm vector so that the interference between the two UEs is minimum. Of course, the smaller the value of cᵤₖ, less correlated the channel vectors of UEs u and k. Therefore, the weight (1−cᵤₖ) is a measure of orthogonality, i.e., uncorrelatedness, between the channel vectors of UEs u and k. Multiplying (1−cᵤᵢ) by the norm of the channel vector of UEᵢ gives the selection metric, according to this invention, which selects the user who's weighted channel norm is maximum.

Step 3: Select the third user, sUE₃≡UEₚ which has the weighted maximum channel norm but accounting for its correlation to the chosen second user's sUE₂≡UEₖ as well as first user's sUE₁≡UEᵤ where

$$\begin{matrix}p = arg {max}_{i} ( ‖ {h}_{ij} {r}_{ij}^{- α / 2} ‖ ( ( 1 - {c}_{ui} ) + ( 1 - {c}_{ki} ) ) ) & \begin{matrix}i = 1 , 2 , … , N and \\ i \neq u \& i \neq k\end{matrix}\end{matrix} \qquad ( 5 )$$

and so on, until N t number of UEs are ranked following to these steps.

After each addition of an sUE to the ordered list, Eq. (2a) that gives the total interference between selected UEs is verified according to the following steps:
If the total interference does not exceed threshold ε, the process continues, until all UEs are selected: Nₜ=Mₜ.
If the total interference exceeds threshold ε, the user selection is truncated at the last selected sUE. The number of sUEs included in the set gives us Nₜ: Nₜ<Mₜ.

The interference may also be more accurately computed using pre-coded user signals.

### Antenna Selection

Antenna selection is decoupled from the user prioritization method explained above. The user prioritization is solved assuming the antennas are selected. Obviously, the initial set of Mₜ antennas are needed to begin the iterative process between user selection and antenna allocation. The initial Mₜ that is less than M_{T} can be selected in several ways. For example, it can be the number of antennas determined in the previous time interval, t−1. Alternatively, it can be the total number of RF-chains available. The number of UEs that are served is equal to total number of antennas, i.e, Nₜ=Mₜ. The ordered set of selected antennas are determined according to the following simple steps:
Step 1: The first antenna is the u^{th} antenna that yields the highest channel norm amongst all Mₜ antennas:

$$\begin{matrix}u = arg {max}_{i} ‖ {h}_{i}^{\hat{}} ‖ & i = 1 , 2 , … , {M}_{t}\end{matrix} \qquad ( 6 )$$

where hᵢ\hat{ }=└h₁ᵢ h₂ᵢ . . . h_{Nti}┘ the i^{th} antenna's channel vector serving NtUEs.
Step 2: The second antenna is the kth antenna that yields the next highest channel norm among all (Mₜ−1) antennas:

$$\begin{matrix}k = arg {max}_{i} ‖ {h}_{i}^{\hat{}} ‖ & i = 1 , 2 , … , {M}_{t} & i \neq u\end{matrix} \qquad ( 7 )$$

Step 3: The third antenna is the p^{th} antenna that yields the next highest channel norm among all (Mₜ−2) antennas:

$$\begin{matrix}k = arg {max}_{i} ‖ {h}_{i}^{\hat{}} ‖ & i = 1 , 2 , … , {M}_{t} and i \neq u \& i \neq k\end{matrix} \qquad ( 8 )$$

and so on, until Mₜ number of antennas are ranked according to these steps, and selected as the set of antennas at time t. The antennas form an ordered set: (sA₁, sA₂, . . . , sA_{Mt})
Iterative Process (set-reduction method)

### Performance Index=0

Step 1: Select group of Mt antennas to serve users: (sA₁, sA₂, . . . , sA_{Mt})
Step 2: Select group of UEs to be served by antennas: (sUE₁, sUE₂, sUE_{Nt})
Step 3: Evaluate the network performance metric such as total C/I (see below). Compare it to the previous cycle's performance metric. If sufficiently close, then exit. Otherwise, execute the next step until a time-out.
Step 4: Set Mₜ=Mₜ−1, Nₜ−Nₜ−1 and go back to Step 1 to repeat the cycle.

### Iterative Process (Set-Extension Method)

### Performance Index is set to 0

Step 1: Select group of Mₜ antennas to serve users: (sA₁, sA₂, . . . , sA_{Mt})
Step 2: Select group of UEs to be served by antennas: (sUE₁, sUE₂, sUE_{Nt})
Step 3: Evaluate the corresponding network performance metric. Compare it to the previous cycle's performance metric. If sufficiently close, then exit. Otherwise, execute the next step until a time-out.
Step 4: Set Mₜ=Mₜ+1 and Nₜ=Nₜ+1 and go back to Step 1 to repeat the cycle.

### Performance Index

In one embodiment, the network performance index can be chosen as the total Carrier to Interference (C/I) ratio as an indication of spectral efficiency of the allocated antennas and selected UEs. This is given by the well-known formula Σᵢlog₂(1+Ψᵢ), where Ψᵢ is the C/I contributed by the i th UE.

The C/I is computed by factoring in precoding since user signals are pre-coded before transmission to reduce channel effects. The general C/I formula for base station j based on ZF-precoding [2] according to precoding vector w is:

$${Ψ}_{i} = \frac{{P}_{t} {\vert {h}_{ij} {w}_{i} {r}_{ij}^{- α / 2} \vert}^{2}}{{\sum }_{k \neq i} {P}_{t} {\vert {h}_{ij} {w}_{k} {r}_{ij}^{- α / 2} \vert}^{2} + {\sum }_{m \neq i , n \neq j} {P}_{t} {\vert {h}_{in} {w}_{m} {r}_{in}^{- α / 2} \vert}^{2}} \qquad ( 9 )$$

The nominator corresponds to the total power of the received signal. The denominator consists of both intra-cell interference received by user i, which equals to Σ_{k≠i}Pₜ[hᵢⱼwₖrᵢⱼ^{-α/2}],² and inter-cell cell interference received by user i which equals to Σ_{m≠i,n≠j}Pₜ[hᵢₙwₘrᵢₙ^{-α/2}]². In this equation, i corresponds to the mobile user, j corresponds to the base station that user i is connected, k corresponds to the user different than user i, which is getting simultaneously served by base station j, and m corresponds to the user connects to base station n and simultaneously served with user i. The following parameters are used in the formula which are well known in prior art.
Pₜ: transmission power
α: Path loss coefficient
wᵢ: beamforming/ZF-pre-coding vector for sUEᵢ.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts a block diagram of a multi-user MIMO radio network.

FIG. 2 Illustrates the prior art scheduling subsystem of base station transmitter according to prior art.

FIG. 3 Illustrates the first method according to invention for user prioritization without antenna selection.

FIG. 4a Illustrates second method according to invention for joint antenna selection and user prioritization in massive MU-MIMO.

FIG. 4b Illustrates the third method according to invention for joint antenna selection and user prioritization in massive MU-MIMO.

FIG. 5 Depicts a high level block diagram of the transmitter with additional subsystems according to invention.

### DETAILED DESCRIPTION OF THE EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

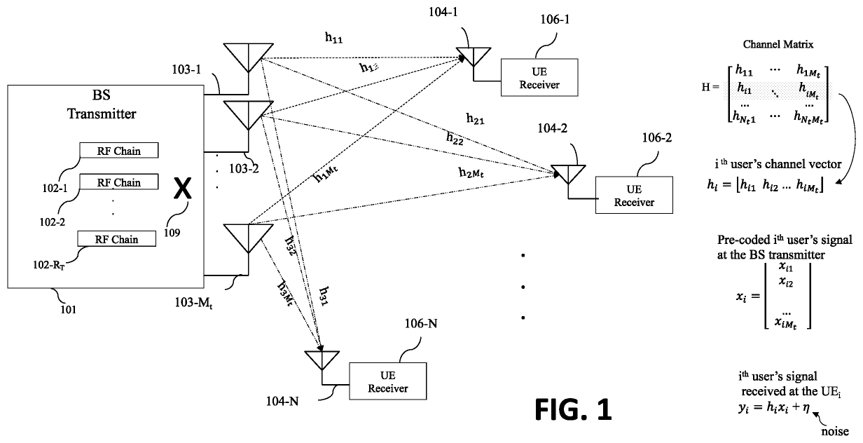

FIG. 1 is a simplified diagram of a MU-MIMO single cell with base station transmitter 101. Base station transmitter 101 has R_{T} number of Radio-Frequency (RF) Chains 102-1, 102-2, . . . , 102-R_{T} and antennas 103-1, 103-2 . . . 103-Mₜ. These antennas and RF-chains may be distributed across a plurality of Radio Units (RUs) or mounted on a single RU. The diagram shows N single-antenna User Equipment (UEs), 106-1, 106-2, . . . , 106-N at different locations within the cell.

The radio channel and the corresponding channel matrix element is hᵢⱼ are marked in FIG. 1 between each BS transmit antenna and UE receive antenna. For example, h₁₂ is the channel matrix element between receive antenna of UE 1 (104-1) and transmit antenna 2 of BS (103-2). Similarly, h_{2Mt} is the channel matrix element between receive antenna of UE 2 (104-2) and Mₜ^{th} transmit antenna of BS (103-Mₜ). The channel matrix, the i^{th} user's channel vector, its pre-coded signal, and the received signal at the i^{th} receiver are also annotated.

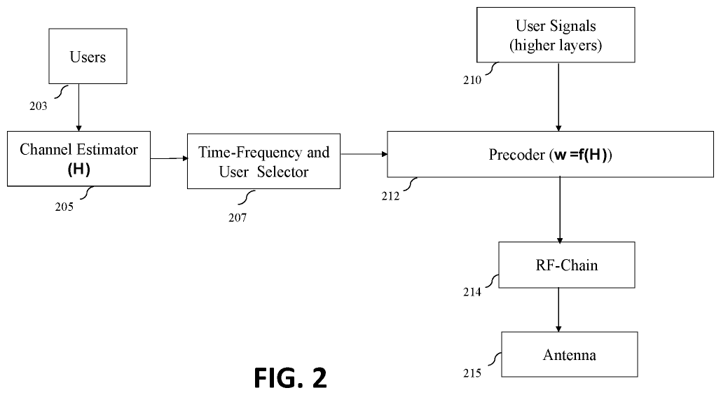

FIG. 2 shows major blocks of a prior art MIMO transmitter that performs scheduling using Channel State Information (CSI). The transmitter estimates the CSI using well- known pilot signals between the base station transmitter and each receiver. In OFDM systems, the forward channel (from the transmitter to receiver) and the reverse channel (from the receiver and transmitter) are not symmetric. Thus, channel reciprocity does not hold. There is no connection between forward channel and reverse channel CSIs. Usually, receiverin the UE obtains an estimation of forward channel CSI through pilot signals sent to it on the forward channel by the BS transmittern the base station, and then informs the transmitter about the estimated CSI. The receiver first sends pilot signals to the transmitter in the base station so that the transmitter can estimate the reverse channel through which the CSI will come. Then, the receiver sends the estimated forward channel CSI over the reverse channel. Since the transmitter now has an estimate of reverse channel, it can derive an estimation of forward channel CST by using standard estimation techniques. Accordingly, Channel Estimator 205 within the transmitter determines the channel matrix. The time-frequency and user selector 207 is the scheduling module that prioritizes the users according to estimated channel matrix, and/or other network measurements using one of the methods well-known in prior art. User signals 210 arrive at the transmitter's physical layer at which the signals are first pre-coded according to a pre-coding matrix that is obtained using the channel matrix. Meaning the amplitude and phase of the user's signal to be transmitted by each beam is determined. Then signals are converted from digital to analog by RF-chain 214 and sent to antenna 215.

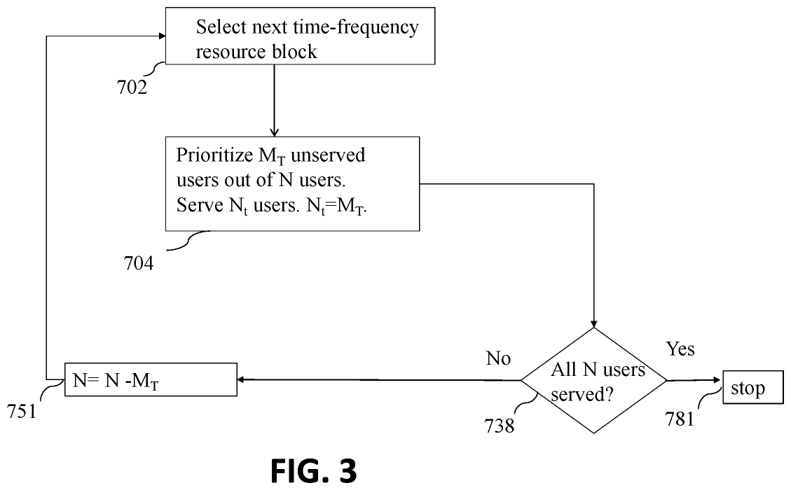

FIG. 3 is the first method according to invention wherein antenna allocation is not needed because all antennas are engaged. The total number of antennas, M_{T}, in the MIMO transmitter is small (e.g., 4, 8, 16 etc.). We assume that the number users to be served, N, is much larger than the number of antennas, i.e., N>>M_{T}. The process starts at step 702 when a resource block (time-frequency) is selected. Thereafter, in step 704, M_{T} users are prioritized at time t using Eqs. (1)-(4). At checkbox 738, the system checks to determine if all N users are served. If yes, the method is completed at step 781. If there are still unserved users, the number of users to be served is reduced by the previously prioritized M_{T} users according to step 751. The process goes back to step 802 and continues until all users are served.

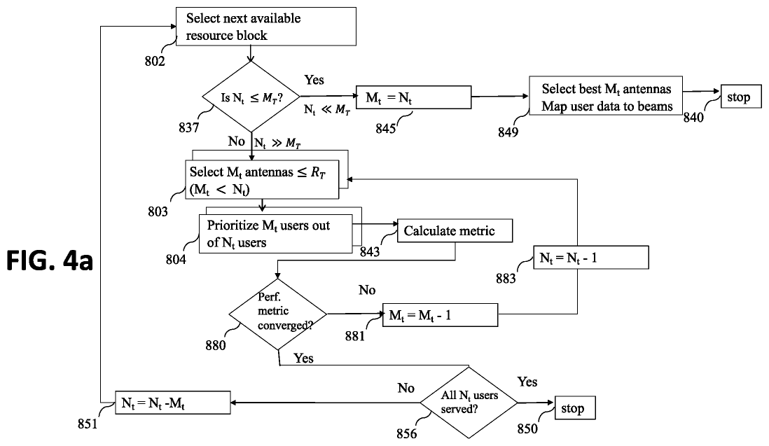

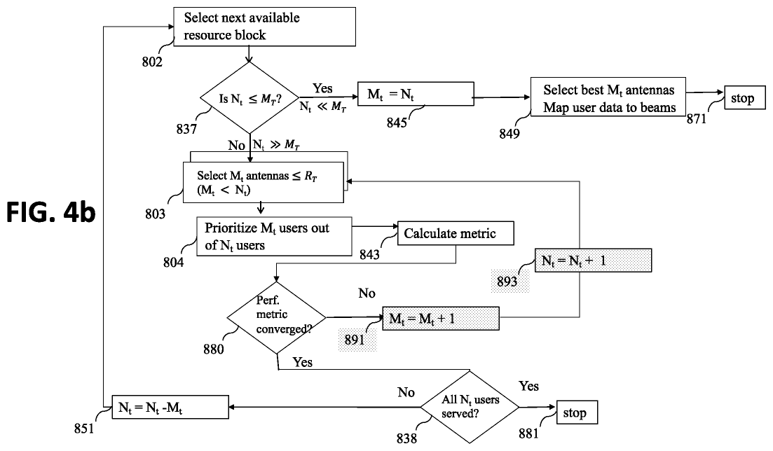

FIG. 4a is the second method according to invention wherein antenna allocation and user prioritization are performed in a decoupled way but using an iterative procedure. The total number of antennas, M_{T}, in the MIMO transmitter is large. The process starts at step 802 when a resource block (time-frequency) is selected. Step 837 checks to determine if the. number of users is smaller (or much smaller) than number of antennas, and if so, in step 845 the number of antennas to use at time t is set to number of users Mₜ=Nₜ. Otherwise, in step 803 Mt antennas are selected and prioritized using Eqs. (5)-(8). The network performance index (NPI) is evaluated at step 843 for the chosen set of antennas and users. An exemplary NPI is Σᵢlog₂(1+Ψᵢ) for all users i, wherein Ψᵢ expression is given Eq. (9). At checkbox 880, the system checks to determine if the PI is close enough to PI of the previous iteration, and if not, it decreases Mₜ and Nₜ by one in steps 881 and 883, respectively, and returns to step 803. Otherwise, it checks to determine if all N users are served. In step 856. If yes, the method is completed at step 850. If there are still unserved users, the number of users to be served is reduced by the previously prioritized M t users according to step 851. The process goes back to 802 and continues until all users are served. FIG. 4b is the third method wherein only steps 891 and 893 are different than the second method, wherein Mₜ and Nₜ are increased by one, respectively.

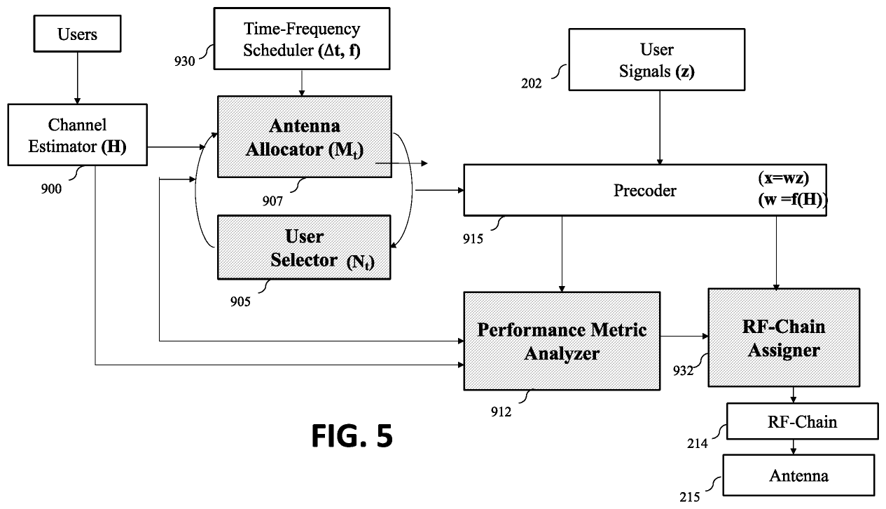

FIG. 5 is a simple block diagram of the base station MU-MIMO transmitter showing only subsystems that pertain to this invention. Many other components of the transmitter are not shown for simplicity. MIMO transmitter that performs scheduling uses Channel State Information (CSI). The transmitter estimates the CSI using pilot signals between the base station transmitter and each receiver. In OFDM systems, the forward channel (from the transmitter to receiver) and the reverse channel (from the receiver and transmitter) are not symmetric. Thus, channel reciprocity does not hold. Therefore, there is no connection between forward channel and reverse channel CSIs. Usually, receiver in the UE obtains an estimation of forward channel CSI through pilot signals sent to it on the forward channel by the BS transmitter, and then informs the transmitter about the estimated CSI. The receiver first sends pilot signals to the transmitter in the base station so that the transmitter can estimate the reverse channel through which the CSI will come. Then, the receiver sends the estimated forward channel CSI over the reverse channel to the transmitter. Since the transmitter now has an estimate of reverse channel, it can derive an estimation of forward channel CSI by using standard estimation techniques. Accordingly, Channel Estimator 900 within the transmitter determines the channel matrix H. The time-frequency scheduler 930 is the scheduling module that determines time and frequency resources only. Antenna Allocator 907 and User Selector 905 receive the channel matrix from Channel Estimator 900, and work iteratively. Performance Metric Analyzer 912 determines whether the method converged or not. It also provides alternative configurable NPIs. User signals 210 arrive at the transmitter's physical layer at which the signals are first precoded according to a pre-coding matrix that is obtained using the channel matrix in 915. Meaning the amplitude and phase of the user's signal to be transmitted by each beam is determined. RF-Chain Assigner 932 determines which RF-chains to assign to chosen Mₜ antennas and activates their connectivity. Then, signals are converted from digital to analog by RF-chain 214 and sent to antenna 215.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

What is claimed is:

1. A method for a radio access network formed by a single cell with massive multi-user MIMO base station with total number of M_{T} antennas, and N number of users to be served at time t where N<M_{T}, the method comprising:
step a: allocating a subset of Mₜ antennas, where Mₜ«M_{T} to serve the users the allocation being performed according to selecting antennas with highest channel norm, step b: prioritizing users to be served by the allocated group of M t antennas in step a, and selecting the top Nₜ users where Nₜ=Mₜ, the selecting users with highest channel norm by factoring in cross-user interference,
step c: evaluating a network performance index and determining if Mₜ is further reduced,
step d: if reducible according to step c, reducing a number of antennas of step a by one, and a number of users by one, and repeating step b, step c and step d, and
step e: otherwise, serving prioritized set of users by determined subset of antennas.

2. A method for a radio access network formed by a single cell with massive multi-user MIMO base station with total number of M_{T} antennas, and N number of users to be served at time t where N<M_{T}, the method comprising:
step a: allocating a subset of Mₜ antennas, where Mₜ«M_{T} to serve the users the allocation being performed according to selecting antennas with highest channel norm,
step b: prioritizing users to be served by the allocated group of Mₜ antennas in step a and selecting the top Nₜ users where Nₜ=Mₜ the selecting users with highest channel norm by factoring in cross-user interference,
step c: evaluating a network performance index and determining if Mₜ is further reduced,
step d: if reducible according to step c, increasing a number of antennas of step a by one, and a number of users by one, and repeating step b, step c, and step d, and
step e: otherwise, serving prioritized set of users by determined subset of antennas.

3. A method for a radio access network formed by a single cell with massive multi-user MIMO base station and N users to be served at time t with total number of antennas, M_{T}, where N>M_{T}, the method comprising:
step a: prioritizing all users to be served by M_{T} antennas to maximize a sum of carrier to interference across all served users using channel orthogonalization,
step b: evaluating a network performance index and determining if a number of antennas is further reduced,
step c: if reducible according to step c, reducing a number of antennas of step a by one and reducing corresponding number of users from previously prioritized users in step b by one and repeating step b, step c, and step d and otherwise, serving prioritized set of users by subset of antennas.

4. The method according to claim 1, wherein the network performance index is a total network carrier to interference ratio.

5. The method according to claim 2, wherein the network performance index is a total network carrier to interference ratio.

6. The method according to claim 3, wherein the network performance index is a total network carrier to interference ratio.

7. The method according to claim 1, wherein the network performance index is a total network carrier to interference ratio divided by total power consumption of the base station to serve the users.

8. The method according to claim 2, wherein the network performance index is a total network carrier to interference ratio divided by total power consumption of the base station to serve the users.

9. The method according to claim 3, wherein the network performance index is a total network carrier to interference ratio divided by total power consumption of the base station to serve the users.
